(19) United States
(12) Patent Application Publication
(10) Pub. No.: US 2004/0208536 A1
(43) Pub. Date: Oct. 21, 2004

(54) Secure interferometric communications in free space

(76) Inventor: Francisco J. Duarte, Rochester, NY (US)

Correspondence Address: Thomas H. Close, Patent Legal Staff, Eastman Kodak Company, 343 State Street, Rochester, NY, 14650-2201, US

(21) Appl. No.: 10/152,474

(22) Filed: May 21, 2002

Related U.S. Application Data
(60) Provisional application No. 60/359,615, filed on Feb. 26, 2002.

(51) Int. Cl. H04B 10/00

(52) U.S. Cl. 398/39

(57) ABSTRACT

N-slit interferometry is applied to generate at least one optical signal representative of an alphabetical or numerical character, symbol, or the like. In particular, the present invention relates to an optical communication system for generating an interferometric character, comprising: a light source emitting a beam of coherent light directed along an optical path; a detector disposed in the optical path; a transmission grating disposed in the optical path intermediate the light source and the digital detector, and a multiple-prism beam expander disposed in the optical path intermediate the light source and the transmission grating adapted to illuminate the transmission grating to generate an interferometric pattern on the detector, the interferometric pattern being representative of the character.

### CROSS REFERENCE TO RELATED APPLICATIONS

This application claims the benefit of U.S. Provisional Application No. 60/359,615, filed on Feb. 26, 2002.

### FIELD OF THE INVENTION

The present invention relates generally to the field of interferometry, and more particularly to N-slit interferometry.

### BACKGROUND OF THE INVENTION

Optical signals have been used in the field of free-space communications, in a modern context, at least since the introduction of the Morse code.

### SUMMARY OF THE INVENTION

The present invention relates to interferometry, and more particularly to an N-slit interferometer, incorporating a one-dimensional, multiple-prism beam expander and used in conjunction with interference calculations to generate interferometric characters for free-space communications. The present invention demonstrates that attempts to intercept these characters optically yield spatial distortions in the interferometric characters. Accordingly, the interferometric approach described herein is applicable to free-space secure communications without the need of cryptographic keys.

Desirable objectives and advantages inherently achieved by the disclosed invention may occur or become apparent to those skilled in the art. The invention is defined by the appended claims.

According to one aspect of the present invention, there is provided an optical communication system for generating an interferometric character. The optical communication system comprises a light source emitting a beam of coherent light directed along an optical path; a detector disposed in the optical path; a transmission grating disposed in the optical path intermediate the light source and the digital detector; and a multiple-prism beam expander disposed in the optical path intermediate the light source and the transmission grating adapted to illuminate the transmission grating to generate an interferometric pattern on the detector, the interferometric pattern being representative of the character.

According to another aspect of the present invention, there is provided a method of generating an optical signal representative of an alphabetic or numeric character, symbol, or the like. The method comprises the steps of: directing a beam of coherent light along an optical path toward a detector; transmitting the beam through a multiple-prism beam expander disposed in the optical path to generate an expanded beam of light; and directing the expanded beam onto a transmission grating disposed in the optical path to generate an interferometric pattern on the detector representative of the alphabetic or numeric character.

According to yet another aspect of the present invention, there is provided a method of interferometric communication. The method includes the steps of (a) directing a substantially pure Gaussian beam of coherent light along an optical path toward a detector; (b) transmitting the Gaussian beam through a multiple-prism beam expander disposed in the optical path to generate an expanded beam of light; (c) directing the expanded beam onto a first transmission grating disposed in the optical path to generate a first interferometric pattern on the detector; (d) detecting the first interferometric pattern on the detector and determining a corresponding alphabetic or numeric character; (e) directing the expanded beam onto a second transmission grating disposed in the optical path to generate a second interferometric pattern on the detector; and (f) detecting the second interferometric pattern on the detector and determining a corresponding alphabetic, numeric, or alphanumeric character.

### BRIEF DESCRIPTION OF THE DRAWINGS

The foregoing and other objects, features, and advantages of the invention will be apparent from the following more particular description of the preferred embodiments of the invention, as illustrated in the accompanying drawings.

FIG. 1 shows a schematic of an optical system comprising a coherent multiple-prism N-slit interferometer in accordance with the present invention.

FIGS. 2(a) through 2(d) show, respectively, the interferometric characters a, b, c, and z, generated using the present invention.

FIG. 3(a) shows an interferometric character a as recorded following unimpeded propagation in free space.

FIGS. 3(b), (c), and (d) show a distorted interferometric character a recorded as an intercepting beam splitter is introduced.

FIG. 3(e) shows a displaced and altered interferometric character a completely intercepted by the beam splitter.

FIG. 4 shows a flow diagram of a method in accordance with the present invention.

FIG. 5 shows a flow diagram of another method in accordance with the present invention.

### DETAILED DESCRIPTION OF THE INVENTION

The following is a detailed description of the preferred embodiments of the invention, reference being made to the drawings in which the same reference numerals identify the same elements of structure in each of the several figures.

Optical signals have been used in the field of free-space communications, in a modern context, at least since the introduction of the Morse code. Recent interest in free-space optical communications has produced a variety of laser-based optical architectures and approaches. References include: (1) S. T. S. Yu, D. A. Gregory, Optical pattern recognition: architectures and techniques, Proc. IEEE 84 (1996) 733-752; (2) P. Boffi, D. Piccinin, D. Mottarella, M. Martinelli, All-optical free-space processing for optical communications signals, Opt. Commun. 181 (2000) 79-88; and (3) H. A. Willebrand, B. S. Ghuman, Fiber optics without fiber, IEEE Spectrum 38 (8) (2001) 40-45.

Interferometric systems are well known electro-optical apparatus. U.S. Pat. No. 5,255,069 (Duarte), commonly assigned and incorporated herein by reference, describes an interferometric system for examining and characterizing ultra fine details of various specimens such as a piece of photographic film. U.S. Pat. No. 6,236,461 (Duarte), commonly assigned and incorporated herein by reference, describes an interferometric system for exposing a sample of light sensitive material to provide a graded series of exposures of different intensity levels.

Applicant has applied interferometry to optical communications. More particularly, the present invention relates to a N-slit interference-based method for secure optical communications. The present invention does not require the use of cryptography.

N-slit interferometry is inherently a free-space optical phenomenon where a generated field interacts with two or more slits, and the resulting interference is recorded at a detection plane by either photographic or digital means. References include: (4) M. Born, E. Wolf, Principles of Optics, Pergamon, New York, 1975; (5) F. J. Duarte, Dispersive dye lasers, in: F. J. Duarte (Ed.), High Power Dye Lasers, Springer, Berlin, 1991. pp. 7-43; (6) F. J. Duarte, On a generalized interference equation and interferometric measurements, Opt. Commun. 103 (1993) 8-14; and (7) F. J. Duarte, Interferometric imaging, in: F. J. Duarte (Ed.), Tunable Laser Applications, Dekker, New York, 1995. pp. 153-178.

Generally, the present invention comprises an optical system including a coherent light source in conjunction with a multiple-prism beam expander. The multiple-beam expander illuminates an array of N-slits in order to generate interference patterns on a detector.

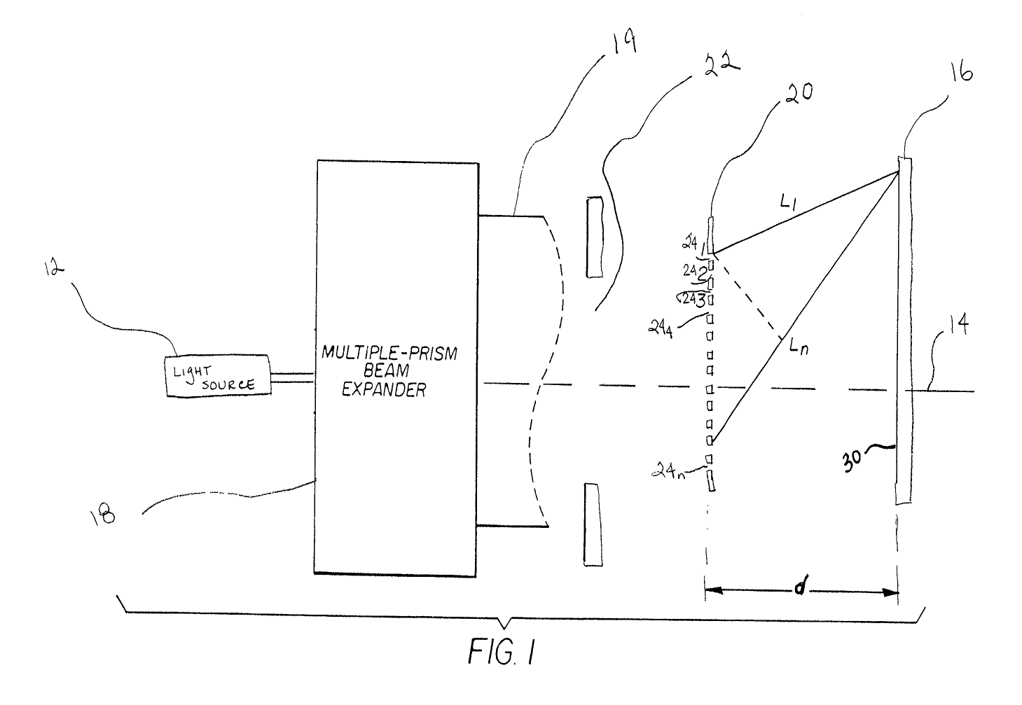

The optical system 10 in accordance with the present invention is generally illustrated in FIG. 1. Optical system 10 comprises a light source 12 emitting a beam of coherent light directed along an optical path 14 toward a detector 16, wherein detector 16 is disposed in optical path 14. In a preferred embodiment, light source 12 incorporates a narrow-linewidth, single-transverse mode HeNe laser emitting a beam polarized parallel to the plane of propagation.

The beam of light propagates through a multiple-prism beam expander 18 to yield an elongated substantially Gaussian beam 19. This beam expansion is preferably one-dimensional and parallel to the plane of propagation. The expanded beam illuminates, with the central part of its distribution, a transmission grating 20. In a preferred embodiment, the central portion of the elongated Gaussian beam (preferably 35-50 mm wide) is allowed to propagate via a wide aperture (preferably 4-6 mm), as shown in FIG. 1 as aperture 22. The near-field diffraction distribution from aperture illuminates transmission grating 20.

Transmission grating 20 comprises a plurality of grating apertures 24₁ through 24ₙ. The plurality of grating apertures is also generally referred to an array of N slits. The interferometric distribution produced propagates in free space until it illuminates detector 16. Detector 16 is preferably a digital detector such as a photodiode array or the like. A photodiode array composed of 1024 elements each 25 μm in width has been suitable for Applicant's experiments.

In the present invention, the N-slit interferometer is applied to generate a series of signals to represent the alphabet, numerics, or the like. For example, using this approach, two slits (i.e., grating apertures) correspond to the letter a, three slits to the letter b, and so forth. Further, using interferometric calculations, the signal to be detected can be predetermined as a function of the slit dimensions, the light source wavelength, and the distance from the slit array (i.e., transmission grating 20) to detector 16. It has been previously determined that there is close agreement between measured and calculated interferograms.

Those skilled in the art will recognize that the present invention can be applied to numerics or other symbols.

It is recognized that the use of a convex lens prior to multiple-prism beam expander 18 is optional.

Results indicate that the interception of the interferometric signal by optical means leads to distortions of the interferogram, indicating that the interferometric signal has been compromised.

Applicant notes that in this work, free space is considered a vacuum or a nearly homogeneous gaseous medium such as air in thermal equilibrium in a laboratory. Scintillation or other phenomena resulting in transmission media inhomogeneities are not considered.

The propagation of coherent light from light source 12 to an imaging plane (here, detector 16), via transmission grating 20, as illustrated in FIG. 1, can be described using Dirac's quantum notation:

$$< x \vert s >= {\sum }_{j = 1}^{N} < x \vert j > < j \vert s > \qquad ( Equation 1 )$$

References: (8) P. A. M. Dirac, The Principles of Quantum Mechanics, Oxford University, London, 1978; (9) R. P. Feynman, R. B. Leighton, M. Sands, The Feynman Lectures on Physics, Addison-Wesley, Reading, 1965; and (10) F. J. Duarte, Interference, diffraction, and refraction, via Dirac's notation, Am. J. Phys. 65 (1997) 637-640.

As indicated in Reference 8 (noted above) and applied elsewhere, the probability amplitudes can be expressed as complex wave functions. Using time independent complex wave functions, the generalized probability distribution, in one dimension, can be written as:

$${\vert < x \vert s > \vert}^{2} = {\sum }_{j = 1}^{N} {\vert Ψ ( {r}_{j} ) \vert}^{2} + 2 {\sum }_{j = 1}^{N} Ψ ( {r}_{j} ) [ {\sum }_{m = j + 1}^{N} Ψ ( {r}_{m} ) cos ( {Ω}_{m} - {Ω}_{j} ) ] \qquad ( Equation 2 )$$

This probability distribution is a function of the laser wavelength, the dimension of the slits, the number of slits, and the spatial distance from the N-slit array to the plane of detection. As previously shown, the spatial parameters, as well as the refractive index of the propagation space, and the laser wavelength are incorporated via the phase difference term of Equation 2. This term can be expressed as:

cos{(θₘ−θⱼ)±(φₘ−φⱼ)}=cos{(lₘ−lₘ₋₁)k₁±(Lₘ−Lₘ₋₁)k₂} (Equation 3)

where k₁=2 πn₁/λᵥ and k₂=2 πn₂/λᵥ. Here (lₘ−lₘ₋₁) and (Lₘ−Lₘ₋₁) refer to the path difference prior, and following, the grating interference, respectively. Similarly, n₁ and n₂ are the indexes of refraction prior and, following, the grating interface, respectively. In this notation λ₁=λᵥ/n₁ and λ₂=λᵥ/n₂ where λᵥ is the wavelength in vacuum. Reference 10 describes the geometry shown in FIG. 1 and relates it to the physics of Equations 2 and 3. This description includes reference to distance d and the dimensions of the slits. Reference: (11) R. Wallenstein, T. W. Hänsch, Linear pressure tuning of a multielement dye laser spectrometer, Appl. Opt. 13 (1974) 1625-1628.

As shown and explained previously, Equation 2 is also used to characterize the diffraction pattern produced at the wide aperture(s) that illuminates the N-slit array. The usefulness of this approach to closely reproduce experimental measurements for two and N-slits arrays has been illustrated in several publications. Equations for the two-dimensional case are given elsewhere. The calculations are performed using programs written in Fortran 90.

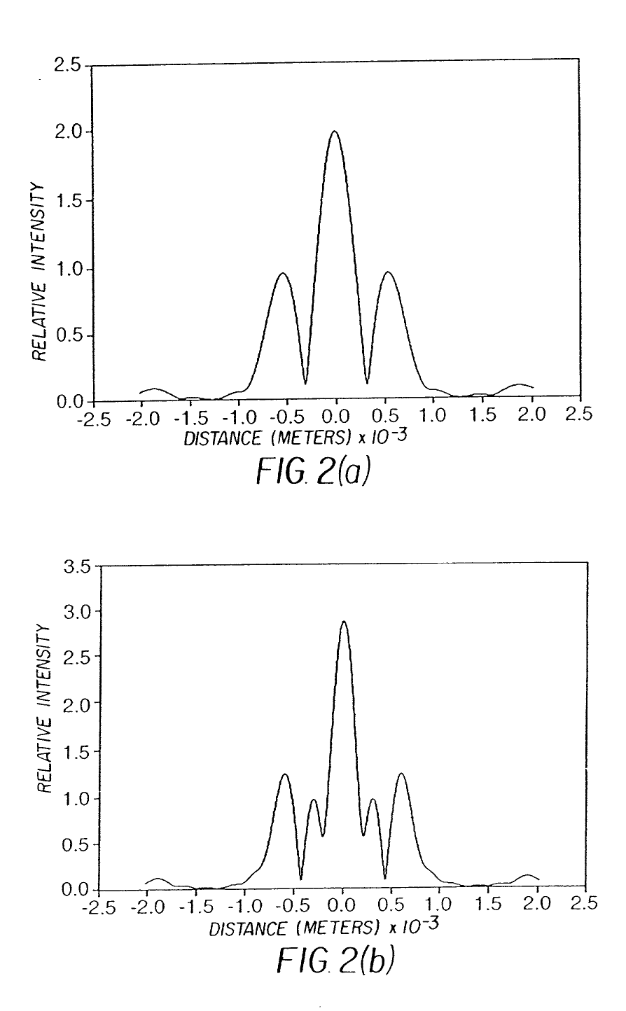

The interferometric architecture, and theoretical approach, described here can be applied to perform free-space communications by creating an interferometric alphabet. A given interferometric alphabet is a function of the laser wavelength, the dimension of the slits, and the free-space distance between the slit array and the detector. For example, for a given set of parameters, the letter a can be represented by two slits, the letter b by three slits, the letter c by four slits, and so on. For slits 50 μm wide, separated by 50 μm, at λ=632.8 nm, and a grating-to-detector distance of 10 cm, the interferometric characters a, b, c, and z are shown in FIGS. 2(a) through 2(d), respectively, generated using the Dirac interference equation. Vertical axis is relative intensity units while the horizontal axis is in meters.

An interesting feature, of practical significance, is that the spatial dimension required to detect all the interferometric characters is within a fairly narrow range. It should also be noted that because there is a free choice of spatial parameters, and wavelengths, the possible number of distinct interferometric alphabets/numerics/symbols is virtually limitless.

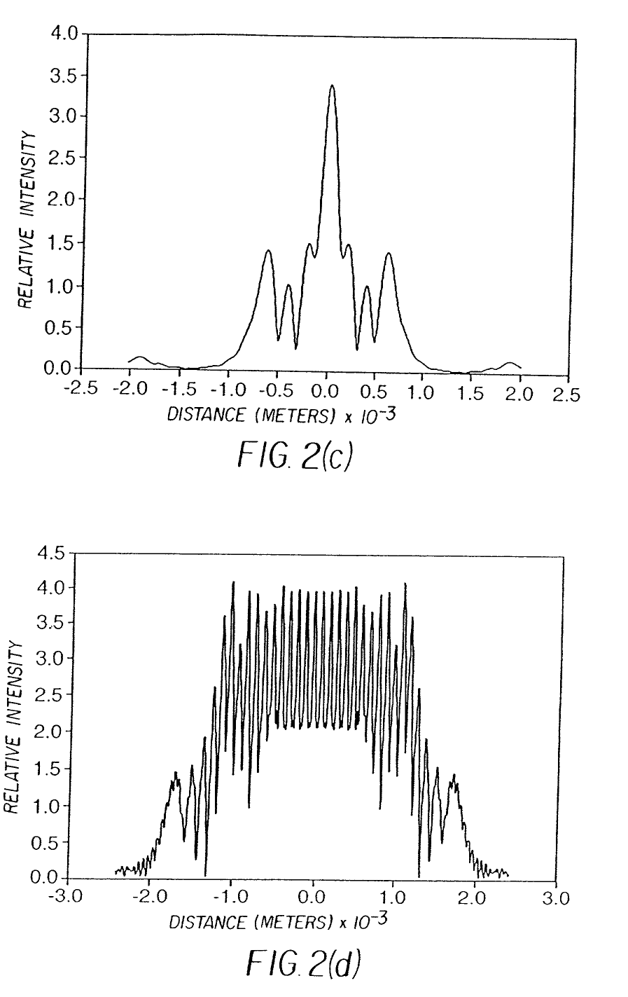

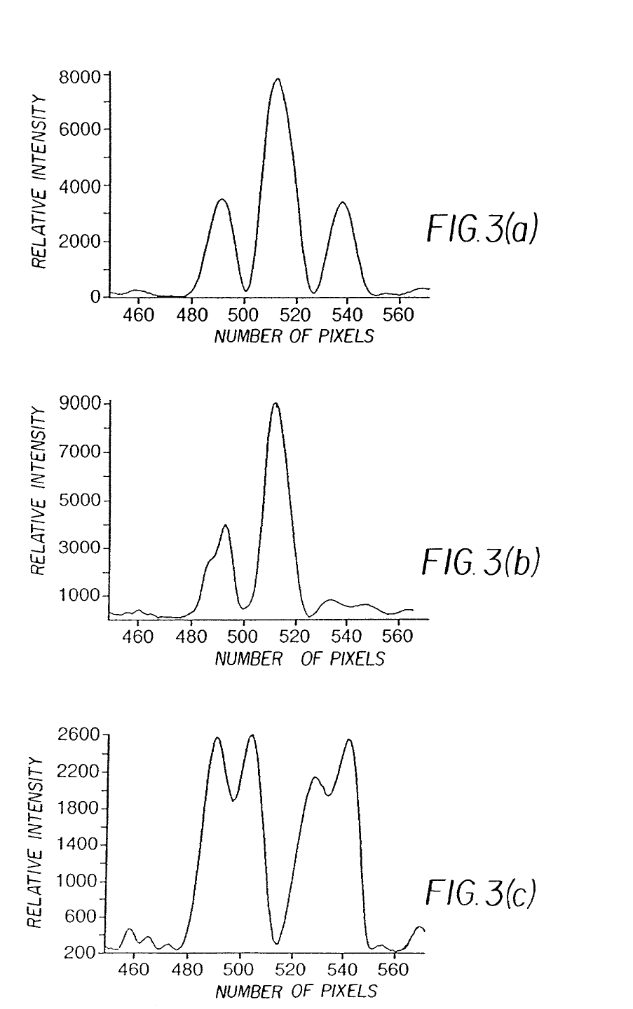

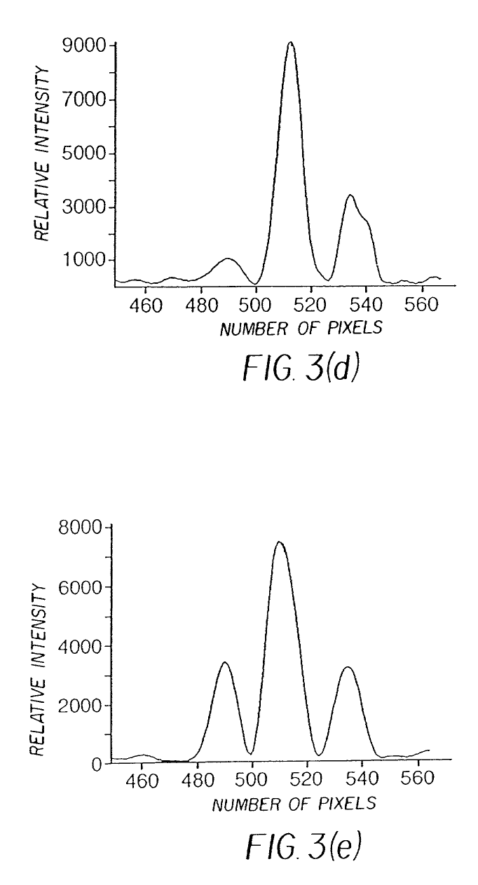

For the case of two 50 μm slits separated by 50 μm, at λ=632.8 nm, and a distance of 10 cm the measured interference distribution is shown in FIG. 3(a). This corresponds to the letter a. That is, FIG. 3(a) shows the interferometric character a as recorded following unimpeded propagation in free space. Each pixel on the horizontal axis represents 25 μm. This letter is selected given that, at short distances, it imposes the most stringent test to the integrity of the transmission.

The integrity of the transmission can be proved by introducing a beam splitter at a given angle to the optical axis. In the present invention, an optically smooth microscope cover slide, with an average thickness of ˜150 μm, was introduced to reflect a small percentage of the interferometric signal. It should be noted that if inserted normal to the transmission path, this optical surface induces no discernable optical distortion except for a slight decrease in intensity, which in this case amounts to ˜8%. The lack of signal distortion induced by this class of thin optical transmission surface, when used at normal incidence, has been previously documented. In FIGS. 3(a)-(e), a sequence of interferometric signals is displayed as the thin beam splitter is introduced into the optical path. More particularly, FIGS. 3(b), (c), and (d) show distorted interferometric character a recorded as an intercepting beam splitter is introduced. FIG. 3(e) shows a displaced and altered interferometric character a completely intercepted by the beam splitter. For FIGS. 3(a)-(e), each pixel on the horizontal axis represents 25 μm.

The angle of incidence is close to, but not equal to, the Brewster angle. The reason for this selection is to cause a minimum of transmission losses whilst still being able to reflect a small fraction of the signal. Significant distortions are caused by the diffraction of the front edge as the beam splitter is displaced forward until it totally intercepts the signal. From the sequence of interferometric images, it is noted that introduction of the diffractive edge rather severely alters the transmitted signal both in the intensity and the spatial domains. During this phase, it is easy to deduce that the signal is being intercepted.

Once the beam splitter is completely in the path of the signal the significant diffraction distortions are no longer present, however, the signal appears modified in three distinct manners. First, the intensity of the signal is decreased, by ˜3.7%, relative to the original intensity. Second, the signal is displaced, by ˜50 μm in the frame of reference of the detector, caused by the refraction induced at the thin beam splitter. Third, there is a slight obliqueness in the intensity distribution as determined from the secondary maxima. These observations indicate that the integrity of the intercepted signal of FIG. 3(e) has been distinctly compromised relative to the spatial and intensity characteristics of the original interferometric distribution depicted in FIG. 3(a). Using the set of slits described above, measurements were also performed at distances up to 100 cm with results very consistent with those already presented.

It is noted that positioning the beam splitter closer to the Brewster angle reduces transmission losses to less than one percent. However, under those circumstances the magnitude of the reflected signal is severely reduced.

In the present invention, an N-slit coherent interferometer incorporates a multiple-prism beam expander to generate a series of distinct optical signals for optical communications. By means of digital detection, it has been shown that attempts to intersect the interferometric characters can be detected by the receiver. This demonstration has been done using the most simple interferometric character corresponding to the letter a. In practice, this would be the most difficult character to display distortions because it has the lowest spatial complexity.

It is noted that the observations have been done in the continuous wave regime. Rapid interception of a given interferometric character produces a sudden distortion followed by the end result shown in FIG. 3(e). Using detectors with a fast response time a sudden distortion can be recorded in a sequence of events similar to that displayed in FIGS. 3(a)-(e).

The method described here is applicable, in principle, to relatively large propagation distances. A limiting factor is the size of the digital detector because as the signal propagates, it increases its spread. The spread of the interferometric distribution can be lowered using wider slits. For example, it can be calculated that two 1 mm slits, separated by 1 mm, produce an interferometric distribution (letter a) bound within 10 cm (for λ=632.8 nm) at a distance of 100 m. Similarly, an array of 26 slits of 1 mm, separated by 1 mm, produce an interferometric distribution (letter z) bound within 14 cm (for λ=632.8 nm) at a distance of 100 m. In practice, this could be done using two off-the-shelf linear photodiode arrays (each 72 mm long) tiled together. If the dimensions of the slits are increased to 3 mm, at λ=632.8 nm, interferometric communications over a distance of 1000 m could be accomplished using six tiled linear photodiode arrays (each 72 mm long). It is recognized that a series of photodiode arrays can provide for interferometric communication over even longer distances. For wavelengths in the near infrared, at the 1 μm range, detection of the interferometric signals requires the use of eight tiled photodiode arrays. The use of shorter wavelengths reduces the spread of the interferometric distributions, thus allowing a reduction of the requirements on the dimensions of detection surfaces. For instance, interferometric communications over a distance of 1000 m could be accomplished using four such tiled photodiode arrays at λ=441.56 nm. For long distance communications, the use of interferometric characters produced by relatively larger number of slits yield finer features that are advantageous in spatial recognition. For example, an a can be comprised by 30 slits, a b by 31 slits, and so forth. It should be emphasized that the calculations show that the interferometric characters thus created are quite distinguishable from each other.

A practical field deployable interferometric system can incorporate a narrow band spectral filter, disposed intermediate transmission grating 20 and detector 16, to allow transmissions during daylight. The filter is preferably adjacent to or abuts detector 16 so as to not distort the interferometric pattern. In a preferred embodiment, the filter is a thin film (e.g., a layer) disposed on detector 16, shown as element 30 in FIG. 1. Because typical narrowband pass filters offer transmission windows, about or less than 1-nm wide, tunable narrow linewidth lasers, with Δν≈375 MHz or better, have an ample spectral region for transmission. Therefore, the filter filters non-interferometric radiation from the interferometric pattern prior to detection of the interferometric pattern by the detector. Reference: (12) F. J. Duarte, Multiple-prism grating solid-state dye laser oscillator: optimized architecture, Appl. Opt. 38 (1999) 6347-6349.

The type of propagation distances discussed herein apply relatively well to free-space communications between buildings and other installations in the line of sight. However, for such applications, secure communications would require statistical analyses of the signals to deal with atmospheric phenomena such as turbulence. This would detract from the simplicity of the method. One environment where this interferometric approach could be applied in its present austerity is outer space where the optical signals propagate in vacuum.

The use of a TEM₀₀ laser emitting in the narrow-linewidth, preferably in a single-longitudinal mode, regime enables the option of incorporating narrow bandwidth filters for communications in daylight conditions. In addition, the availability of nearly monochromatic light yields predictable sharper and well-defined interferometric distributions as compared to the generation of signals utilizing broadband radiation. Versatility to this technique can be added via the use of tunable lasers, which can allow rapid change in the profile of a given character or by incorporating precision variable slit arrays.

Optical cryptography is a well-established field where quantum cryptography plays a prevalent role. Quantum cryptography provides security guaranteed by the uncertainty principle and has been shown to be applicable over distances in the tens of kilometers range. This technique is based on single photon emission and detection. Reference: (13) B. C. Jacobs, J. D. Franson, Quantum cryptography in free space, Opt. Lett. 21, (1996) 1854-1856. The interferometric technique described here provides security via the principles of diffraction, refraction, and reflection. Advantages include a considerably simpler optical architecture and the use of relatively high optical powers although, in principle, it could also be applied to single-photon emission.

An N-slit interferometer, incorporating a one-dimensional multiple-prism beam expander has been used in conjunction with interference calculations to generate interferometric characters for free-space communications. It has been demonstrated that attempts to intercept these characters optically yield spatial distortions in the interferometric characters. Hence, the interferometric approach described here is applicable to free-space secure communications without the need of cryptographic keys.

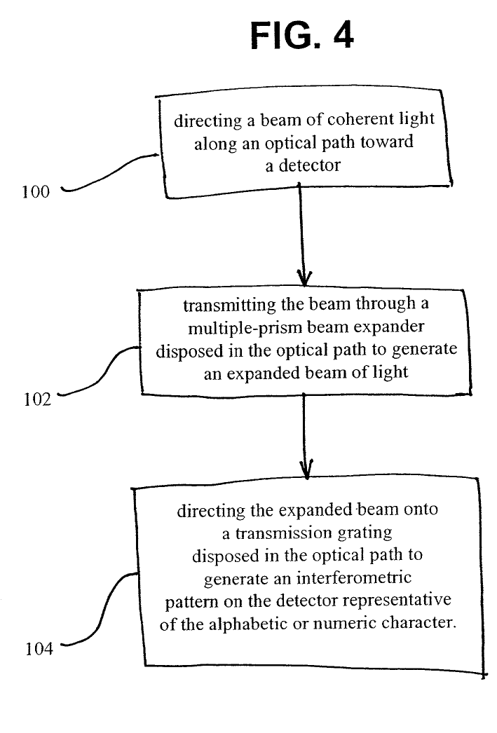

FIG. 4 shows a flow diagram of a method in accordance with the present invention employing optical system 10. More particularly, FIG. 4 shows a flow diagram of a method of generating an optical signal representative of an alphabetic or numeric character. At step 100, a beam of coherent light from light source 12 is directed along optical path 14 toward detector 16. The beam is transmitted through multiple-prism beam expander 18 disposed in optical path 14 to generate expanded beam of light 19 (step 102). At step 104, expanded beam 19 is directed onto transmission grating 20 disposed in optical path 14 to generate an interferometric pattern on detector 16 representative of the alphabetic or numeric character. In an optional step, expanded beam 19 is directed through a narrow bandwidth filter disposed in optical path 14 intermediate the transmission grating 20 and detector 16 prior to the generation of the interferometric pattern on detector 16.

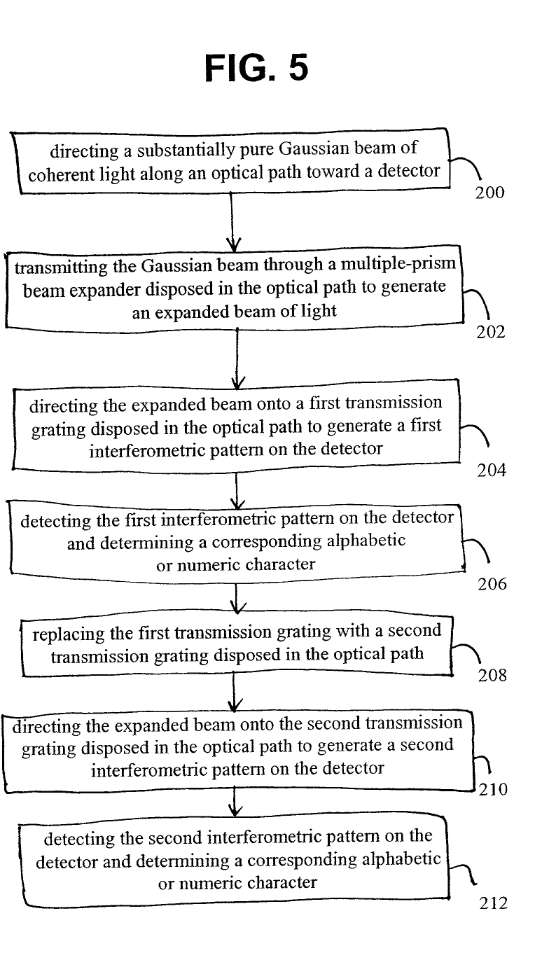

FIG. 5 shows a flow diagram of another method in accordance with the present invention employing optical system 10 wherein a plurality of alphabetic and/or numeric characters are generated. More particularly, FIG. 5 shows a method of interferometric communication. At step 200, a substantially pure Gaussian beam of coherent light from light source 12 is directed along optical path 14 toward detector 16. The Gaussian beam is transmitted through multiple-prism beam expander 18 disposed in optical path 14 to generate expanded beam of light 19 (step 202). At step 204, expanded beam 19 is directed onto a first transmission grating 20′ disposed in optical path 14 to generate a first interferometric pattern on detector 16; the first interferometric pattern is detected on detector 16, and the corresponding alphabetic or numeric character is determined (step 206). First transmission grating 20′ is replaced/exchanged/moved so as to dispose a second transmission grating 20″ in optical path 14 (step 208). Expanded beam of light 19 is directed onto second transmission grating 20″ to generate a second interferometric pattern on detector 16 (210). The second interferometric pattern is detected on detector 16, and the corresponding alphabetic or numeric character is determined (step 212).

The steps of replacing/moving the transmission grating with another transmission grating and detecting the new corresponding interferometric pattern generated (i.e., steps 208 through 212) can be repeated with other transmission gratings, whereby a message (such as a word, phrase, sentence, signal) are generated for communication. The different transmission gratings can be separate, distinct gratings. Alternatively, the different transmission gratings can be disposed on a single structure which is moved, rotated, translated, or the like, to dispose the selected transmission grating in the optical path.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

Parts List

10 optical system

12 light source

14 optical path

16 detector

18 multiple-prism beam expander

19 Gaussian beam

20 transmission grating

22 aperture

24₁-24_{N} grating apertures

30 element

What is claimed is:

1. An optical communication system for generating an interferometric character, comprising:
a light source emitting a beam of coherent light directed along an optical path;
a detector disposed in the optical path;
a transmission grating disposed in the optical path intermediate the light source and the digital detector; and
a multiple-prism beam expander disposed in the optical path intermediate the light source and the transmission grating adapted to illuminate the transmission grating to generate an interferometric pattern on the detector, the interferometric pattern being representative of the character.

2. The optical system of claim 1, wherein the beam is one dimensional.

3. The optical system of claim 1, wherein the beam is polarized parallel to the optical path.

4. The optical system of claim 1, wherein the light source is laser emitting a substantially pure Gaussian beam of light at a predetermined wavelength.

5. The optical system of claim 1, wherein the detector is a digital detector or a photographic detector.

6. The optical system of claim 1, wherein the detector is a photodiode array.

7. The optical system of claim 1, wherein the transmission grating comprises a plurality of apertures.

8. The optical system of Clam 7, wherein the plurality of apertures are of varying sizes.

9. The optical system of claim 1, wherein the interferometric pattern is a function of the dimension of each of the plurality of apertures.

10. The optical system of claim 1, wherein the interferometric pattern is a function of the number of the plurality of apertures.

11. The optical system of claim 1, wherein the interferometric pattern is a function of the wavelength of the light source.

12. The optical system of claim 1, wherein the interferometric pattern is a function of the distance between the transmission grating and the detector along the optical path.

13. The optical system of claim 1, wherein the interferometric pattern is representative of an alphabetic character, numeric character, alphanumeric character, or symbol.

14. The optical system of claim 1, further comprising a filter disposed in the optical path intermediate the transmission grating and the detector.

15. The optical system of claim 14, wherein the filter is adjacent or abutting the detector.

16. The optical system of claim 14, wherein the filter is a narrow bandwidth filter.

17. The optical system of claim 14, wherein the filter is compatible with the light source.

18. The optical system of claim 14, wherein the filter is a layer disposed on one side of the detector.

19. The method of claim 1, further comprising the step of detecting an optical integrity of the character by comparing the interferometric pattern with a predetermined interferometric pattern.

20. A method of generating an optical signal representative of an alphabetic or numeric character, comprising the steps of:
directing a beam of coherent light along an optical path toward a detector;
transmitting the beam through a multiple-prism beam expander disposed in the optical path to generate an expanded beam of light; and
directing the expanded beam onto a transmission grating disposed in the optical path to generate an interferometric pattern on the detector representative of the alphabetic or numeric character.

21. The method of claim 20, further comprising the step of detecting the interferometric pattern on the detector and determining a corresponding alphabetic or numeric character.

22. The method of claim 20, further comprising the step of directing the expanded beam through a narrow band spectral filter disposed in the optical path intermediate the transmission grating and the detector.

23. A method of interferometric communication, comprising the steps of:
(a) directing a substantially pure Gaussian beam of coherent light along an optical path toward a detector;
(b) transmitting the Gaussian beam through a multiple-prism beam expander disposed in the optical path to generate an expanded beam of light;
(c) directing the expanded beam onto a first transmission grating disposed in the optical path to generate a first interferometric pattern on the detector;
(d) detecting the first interferometric pattern on the detector and determining a corresponding alphabetic or numeric character;
(e) directing the expanded beam onto a second transmission grating disposed in the optical path to generate a second interferometric pattern on the detector; and
(f) detecting the second interferometric pattern on the detector and determining a corresponding alphabetic, numeric, or alphanumeric character.

24. The method of claim 23, further comprising the step of, prior to directing the expanded beam on the second transmission grating, replacing the first transmission grating with the second transmission grating disposed in the optical path;

25. The method of claim 23, further comprising the step of filtering non-interferometric radiation from the interferometric pattern prior to detecting the first and second interferometric pattern on the detector.

26. The method of claim 23, further comprising the step of detecting an optical integrity of the alphabetic or numeric character by comparing the first interferometric pattern with a calculated interferometric pattern.

27. The method of claim 23, further comprising the step of repeating steps (e) and (f) for a third transmission grating.
